(19) United States
(12) Patent Application Publication
(10) Pub. No.: US 2025/0379532 A1
(43) Pub. Date: Dec. 11, 2025

(54) METHOD FOR OPTIMIZING OPERATING ACCURACY OF BRUSHLESS WINCH MOTOR

(71) Applicant: Zhejiang Nowvow Mechanical and Electrical Corp., Ltd., Zhejiang (CN)

(72) Inventors: JUN ZHOU, Zhejiang (CN); CHUNXIANG ZHANG, Zhejiang (CN)

(21) Appl. No.: 18/888,640

(22) Filed: Sep. 18, 2024

(30) Foreign Application Priority Data
Jun. 6, 2024 (CN) 2024107320273

(51) Int. Cl. H02P 21/34; B66D 1/48; H02P 21/00; H02P 21/18; H02P 21/22

(52) U.S. Cl. CPC H02P 21/34; B66D 1/485; H02P 21/0014; H02P 21/18; H02P 21/22; H02P 2207/05

(57) ABSTRACT

A method for optimizing operating accuracy of a brushless winch motor includes outputting a d-axis reference current and a rotor position according to a winch motor startup signal using a flux linkage observer-based sensorless observer model and a motor model; obtaining a real-time rotational speed and a real-time winding/unwinding position of the winch motor according to an operating parameter of the winch motor using the flux linkage observer-based sensorless observer model and the motor model; and obtaining a first offset between the real-time winding/unwinding position of the winch motor and a preset position and a second offset between the real-time rotational speed of the winch motor and a preset rotational speed, performing closed-loop control of the operating parameter with the first offset and the second offset as feedback parameters, and adjusting the operating parameter to optimize operating accuracy of the winch motor.

### CROSS-REFERENCE TO RELATED APPLICATIONS AND CLAIM OF PRIORITY

This application claims the benefit under 35 USC § 119 of Chinese Patent Application Nos. 2024107320273, filed on Jun. 6, 2024, in the China Intellectual Property Office, the entire disclosure of which is incorporated herein by reference for all purposes.

### BACKGROUND

### 1. Technical Field

The present application relates to the technical field of operating accuracy optimization of a permanent magnet DC brushless motor for a winch (hereinafter referred to as “winch motor”), and more particularly relates to a method for optimizing operating accuracy of a brushless winch motor.

### 2. Background Art

A winch is a hauling or lifting device driven by a power to move an object. The winch is driven by an electric motor to create a torque, where a coupler and a drive rod drive a reduction gearbox to output the torque to bring a winch drum to rotate, so that the winch performs hauling or lifting by winding a rope around the winch drum. Operation of the winch may be controlled by a controller in a wired or wireless manner.

Existing winches are mainly driven by an alternating-current (AC) asynchronous motor. When the asynchronous motor is operating, a rotor winding absorbs part of electrical energy from a power grid for magnetic excitation, which consumes electrical energy of the power grid; this part of electrical energy is partially dissipated in a form of heat as the electrical current flows in the rotor winding, the loss rate of which accounts for 20%˜30% of the total motor loss, resulting in degraded motor efficiency. Some existing winches use a permanent magnet brushless motor; without induced current for magnetic excitation in the rotor of the permanent magnet motor, the stator winding likely exhibits a purely resistive load, so that the motor power factor is almost 1. When the permanent magnet synchronous motor has a load ratio >20%, there is not much change in its working efficiency and power factor, where the working efficiency can reach as high as 80% above with low heat generation. The electric winch products adopting sensorless field-oriented control (FOC) for the permanent magnet motor offer various advantages: 1. the installation configuration of the permanent magnet brushless motor is simplified; without a Hall sensor configuration, the overall cost of the product is reduced; 2. since the Hall sensor is susceptible to various factors such as moisture, temperature, and electromagnetic interference, the sensorless approach can significantly lower the defect rate or reject rate of the products; 3. the FOC control can satisfy practical application requirements of the electric winches, such as constant current, constant power, and constant rotational speed.

However, due to inaccuracy or real-time dynamic change of a motor parameter, control accuracy is likely degraded, which might also affect stability and convergence of the sensorless FOC control algorithm, resulting in deteriorated motor operating accuracy.

The Chinese Patent Publication No. CN113241985A entitled Apparatus and Method for Position Sensorless Current Self-Calibration Control of Magnetically Suspended Flywheel (Publication Date: Aug. 10, 2021) specifically discloses updating in real time an online identified electrical parameter of a permanent magnet synchronous motor to a current loop proportional-integral (PI) controller to achieve self-calibration, and meanwhile updating an electrical parameter of a rotor position observer to enhance its estimation accuracy. The method includes: step 1: online identifying an electrical parameter of a permanent magnet synchronous motor using a variable regularized affine projection fractional-step algorithm, and updating in real time the electrical parameter to a current loop PI controller and a rotor position observer; step 2: updating in real time, by the voltage feed-forward decoupled current loop PI controller, the electrical parameter to achieve self-calibration; step 3: estimating, by the rotor position observer, a-axis and β-axis extended counter-electromotive forces via a sliding mode observer, and obtaining estimated rotational speed and estimated position information of the motor in conjunction with a normalized phase-locked loop. This solution only realizes self-calibration of the electrical parameter, but cannot dynamically change the rotational speed or power of the motor when the motor load varies, failing to optimize operating accuracy of the motor.

The Chinese Patent Publication No. CN113346798A entitled Sensorless Velocity Control Method for Permanent Magnet Synchronous Motor (Publication Date: Sep. 3, 2021) specifically discloses: acquiring three-phase alternating current of the permanent magnet synchronous motor to obtain α-axis and β-axis currents i_{α} and i_{β} in a two-phase rotational coordinate system; transforming the i_{α} and i_{β} based on an electrical angle θₑ of a rotor of the permanent magnet synchronous motor to obtain d-axis and q-axis currents i_{d} and i_{q} in a two-phase stationary coordinate system; constructing a current complex vector iₛ using the i_{d} and i_{q}, and constructing a voltage complex vector us based on the iₛ using a PI controller and an electrical angular velocity ωₑ of the rotor; obtaining d-axis voltage u_{d} and q-axis voltage u_{q} in a two-phase stationary coordinate system based on the uₛ; transforming the u_{d} and u_{q} based on the θₑ to obtain α-axis and β-axis voltages u_{α} and u_{β} in a two-phase rotational coordinate system; obtaining a three-phase square wave duty cycle based on modulated u_{α} and u_{β}, thereby controlling current of the permanent magnet synchronous motor and then controlling a torque thereof. This solution realizes speed control by adjusting the torque of the permanent magnet synchronous motor via the current; however, it cannot accurately control operating timing of the permanent magnet synchronous motor in a high-accuracy control.

### SUMMARY

The present application provides a method for optimizing operating accuracy of a brushless winch motor to overcome a problem that existing winch motors have a lower dynamic optimization accuracy and cannot satisfy requirements of high-accuracy control; by dynamically obtaining a flux linkage variation via a flux linkage observer, calculating a dynamic rotor position to thereby calculate a real-time rotational speed and a real-time winding/unwinding position of the winch motor, calculating an offset of an operating parameter of the winch motor based on the offset between the real-time rotational speed of the winch motor and a preset rotational speed and an offset between the real-time winding/unwinding position of the winch motor and the preset position, and performing feedback-based control to compensate for the operating time offset and operating power offset caused by the preceding offsets, the present application can satisfy the requirement of high-accuracy control.

To achieve the above technical objective, the present application provides a technical solution below: a method for optimizing operating accuracy of a brushless winch motor, including: S1: obtaining a basic parameter of the winch motor, building a motor model based on the basic parameter of the winch motor, and building a flux linkage observer-based sensorless observer model based on the motor model; S2: obtaining a winch motor startup signal at startup of the winch motor, outputting a d-axis reference current and a rotor position according to the winch motor startup signal using the flux linkage observer-based sensorless observer model and the motor model, and adjusting a winch motor startup parameter based on the d-axis reference current and the rotor position; S3: monitoring an operating parameter of the winch motor in real time, and obtaining a real-time rotational speed and a real-time winding/unwinding position of the winch motor according to the operating parameter of the winch motor using the flux linkage observer-based sensorless observer model and the motor model; and S4: obtaining a first offset between the real-time winding/unwinding position of the winch motor and a preset position and a second offset between the real-time rotational speed of the winch motor and a preset rotational speed, performing closed-loop control of the operating parameter with the first offset and the second offset as feedback parameters, and adjusting the operating parameter to optimize operating accuracy of the winch motor. By building a motor model based on a basic parameter of the winch motor, then calculating a d-axis reference current and an initial rotor position by analyzing motor voltage and current signals using the flux linkage observer-based sensorless observer model and the motor model at startup of a winch, and adjusting the startup parameter of the winch motor based on the d-axis reference current and the rotor position information, the startup operating accuracy of the winch motor is enhanced, which ensures stable and effective startup of the motor. During operating of the motor, by monitoring the operating parameter of the winch motor in real time, dynamically obtaining a real-time winding/unwinding position and a real-time rotational speed of the winch motor based on variation of the operating parameter of the winch motor, comparing the real-time winding/unwinding position and the real-time rotational speed with the preset position and the preset rotational speed to obtain a first offset and a second offset, performing closed-loop control with the first offset and the second offset as feedback parameters, and constantly adjusting the operating parameter of the winch motor to respond to motor load variation and position change, the operating accuracy of the winch motor is enhanced; meanwhile, based on results of real-time monitoring and sensorless observer model analysis, it is enabled to monitor in real time whether the motor is in an abnormal state such as overload, rotating stall, etc., so that corresponding protective measures may be taken in time to prevent damages to the winch motor, whereby stability and reliability of the winch motor are enhanced.

Furthermore, step S2 further includes: converting a winch motor startup current via Clark transformation to a current parameter in a two-phase stationary coordinate system; converting the current parameter in the two-phase stationary coordinate system via Park transformation to a current parameter in a two-phase rotational coordinate system; and outputting a d-axis reference current and a rotor position according to the current parameter in the two-phase rotational coordinate system and a preset operating parameter of the winch motor using the flux linkage observer-based sensorless observer model and the motor model.

Furthermore, the outputting a d-axis reference current and a rotor position according to the current parameter in the two-phase rotational coordinate system and a preset operating parameter of the winch motor using the flux linkage observer-based sensorless observer model and the motor model further includes: outputting a q-axis flux linkage using the current parameter in the two-phase rotational coordinate system as an input to the flux linkage observer-based sensorless observer model; outputting the rotor position based on a change rate of the q-axis flux linkage; and outputting the d-axis reference current based on the preset operating parameter of the winch motor and the motor model.

Furthermore, step S1 further includes: building a basic parameter timing variation model of the winch motor based on historical basic parameter data of the winch motor, and outputting the basic parameter of the winch motor based on present timing and the basic parameter timing variation model of the winch motor.

Furthermore, the obtaining a real-time rotational speed and a real-time winding/unwinding position of the winch motor according to the operating parameter of the winch motor using the flux linkage observer-based sensorless observer model further includes: outputting an angular velocity according to the operating parameter of the winch motor using the flux linkage observer-based sensorless observer model, and calculating the real-time rotational speed and the real-time winding/unwinding position according to the angular velocity.

Furthermore, step S2 further includes: outputting the preset position and the preset rotational speed according to the winch motor startup signal using the motor model.

Furthermore, step S4 further includes: calculating, based on the first offset, a compensating value for the second offset, performing closed-loop control of the operating parameter with the second offset and the compensating value for the second offset as feedback parameters, and adjusting the operating parameter to optimize operating accuracy of the winch motor.

Furthermore, the method for optimizing operating accuracy of a brushless winch motor further includes S0 before performing S1: obtaining a relevance function between a rope travel length of the winch motor and a rotor angle of the winch motor.

Furthermore, step S3 further includes: obtaining a corresponding relevance function between the rope travel length of the winch motor and the rotor angle of the winch motor based on winch parameters, and outputting the real-time winding/unwinding position based on the relevance function and a mechanical angle of the winch motor.

Furthermore, step S3 further includes: monitoring the operating parameter of the winch motor in real time, outputting real-time current of the winch motor according to the operating parameter of the winch motor using the flux linkage observer-based sensorless observer model and the motor model, and when the real-time current of the winch motor exceeds a preset current threshold, controlling the motor to stop.

The present application offers the following benefits: by obtaining the first offset between the real-time winding/unwinding position of the winch motor and the preset position and the second offset between the real-time rotational speed of the winch motor and the preset rotational speed, a compensating rotational speed for the winch motor required to hoist the object to the destination within the preset time and/or a compensating power for the winch motor required to hoist the object to the destination under a constant power are/is calculated as feedback parameters to adjust the operating parameter of the motor, so as to satisfy high-accuracy control as to operating time control and hoist torque control, which ensures stable lifting of the object and enhances operating accuracy of motor control.

### BRIEF DESCRIPTION OF THE DRAWING

FIG. 1s a flow diagram of a method for optimizing operating accuracy of a brushless winch motor according to the disclosure.

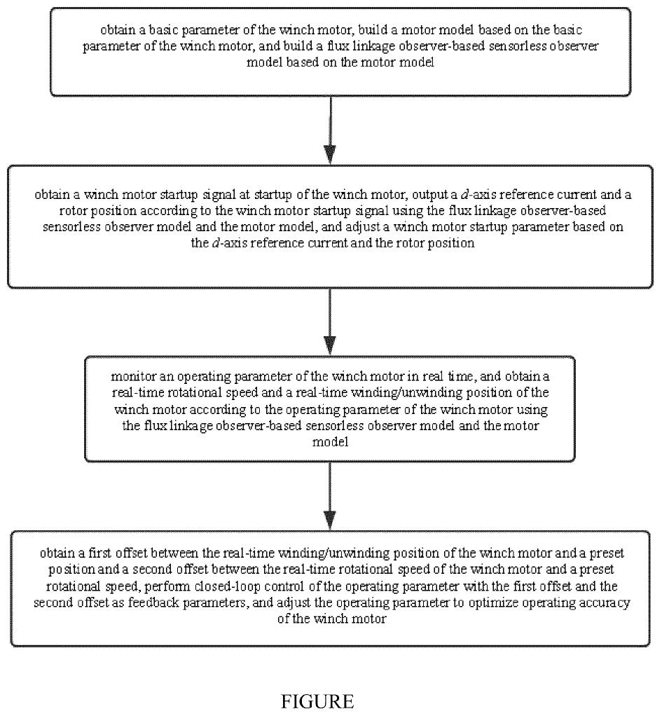

### DETAILED DESCRIPTION OF EMBODIMENTS

To make the objectives, technical solutions, and advantages of the disclosure more apparent, the disclosure will be described in a clear and comprehensive manner through implementations with reference to the accompanying drawings; it is understood that the implementations described herein are only best modes of the embodiments of the disclosure, which are only intended for explaining the disclosure, not for limiting the protection scope of the disclosure. All other implementations derived by a person of ordinary skill in the art without exercise of inventive work fall within the protection scope of the disclosure.

As illustrated in FIGURE, a first implementation of the disclosure provides a method for optimizing operating accuracy of a brushless winch motor, including the following steps:

S1: obtaining a basic parameter of the winch motor, building a motor model based on the basic parameter of the winch motor, and building a flux linkage observer-based sensorless observer model based on the motor model;

S2: obtaining a winch motor startup signal at startup of the winch motor, outputting a d-axis reference current and a rotor position according to the winch motor startup signal using the flux linkage observer-based sensorless observer model and the motor model, and adjusting a winch motor startup parameter based on the d-axis reference current and the rotor position;

S3: monitoring an operating parameter of the winch motor in real time, and obtaining a real-time rotational speed and a real-time winding/unwinding position of the winch motor according to the operating parameter of the winch motor using the flux linkage observer-based sensorless observer model and the motor model; and

S4: obtaining a first offset between the real-time winding/unwinding position of the winch motor and a preset position and a second offset between the real-time rotational speed of the winch motor and a preset rotational speed, performing closed-loop control of the operating parameter with the first offset and the second offset as feedback parameters, and adjusting the operating parameter to optimize operating accuracy of the winch motor.

In this implementation, by building a motor model based on a basic parameter of the winch motor, then calculating a d-axis reference current and an initial rotor position by analyzing motor voltage and current signals using the flux linkage observer-based sensorless observer model and the motor model at startup of a winch, and adjusting the startup parameter of the winch motor based on the d-axis reference current and the rotor position information, the startup operating accuracy of the winch motor is enhanced, which ensures stable and effective startup of the motor. During operating of the motor, by monitoring the operating parameter of the winch motor in real time, dynamically obtaining a real-time winding/unwinding position and a real-time rotational speed of the winch motor based on variation of the operating parameter of the winch motor, comparing the real-time winding/unwinding position and the real-time rotational speed with the preset position and the preset rotational speed to obtain a first offset and a second offset, performing closed-loop control with the first offset and the second offset as feedback parameters, and constantly adjusting the operating parameter of the winch motor to respond to motor load variation and position change, the operating accuracy of the winch motor is enhanced; meanwhile, based on results of real-time monitoring and sensorless observer model analysis, it is enabled to monitor in real time whether the motor is in an abnormal state such as overload, rotating stall, etc., so that corresponding protective measures may be taken in time to prevent damages to the winch motor, whereby stability and reliability of the winch motor are enhanced.

The basic parameter of the winch motor at least includes resistance, inductance, and flux linkage. The motor model at least includes a voltage equation, a flux linkage equation, a torque equation, and a motion equation. The flux linkage observer-based sensorless observer model is constructed using the voltage equation:

$${U}_{d} = {R}_{s} \cdot {I}_{d} + {L}_{d} \cdot {pI}_{d} - {ω}_{e} \cdot {L}_{q} \cdot {I}_{q} ;$$

$${U}_{q} = {R}_{s} \cdot {I}_{q} + {L}_{q} \cdot {pI}_{q} - {ω}_{e} \cdot {L}_{d} \cdot {I}_{d} + {ω}_{e} \cdot {ϕ}_{f} ;$$

$${ϕ}_{d} = {L}_{d} {I}_{d} + {ϕ}_{f} ;$$

$${ϕ}_{q} = {L}_{q} {I}_{q}$$

where U_{d} denotes a d-axis voltage of the winch motor, Rₛ denotes an internal resistance of the winch motor, I_{d} denotes a d-axis current of the winch motor, L_{d} denotes a d-axis inductance of the winch motor, denotes a differential operator, ωₑ denotes an electrical angular velocity of the winch motor, L_{g} denotes a q-axis inductance of the winch motor, U_{q} denotes a q-axis voltage of the winch motor, I_{q} denotes a q-axis current of the winch motor, ϕ_{f} denotes a flux linkage of the permanent magnet, ϕ_{d} denotes a d-axis flux linkage, ϕ_{q} denotes a q-axis flux linkage.

At startup of the winch motor, the winch motor has an initial voltage and an initial current, which are the basis for outputting the d-axis reference current and the rotor position using the flux linkage observer-based sensorless observer model and the motor model. In AC motor control, it is needed to convert an AC electrical signal to a direct-current (DC) electrical signal for simpler control and decoupling. The winch motor startup signal at least includes a winch motor startup current and a winch motor preset operating parameter; therefore, step S2 further includes:
converting a winch motor startup current via Clark transformation to a current parameter in a two-phase stationary coordinate system;
converting the current parameter in the two-phase stationary coordinate system via Park transformation to a current parameter in a two-phase rotational coordinate system; and
outputting a d-axis reference current and a rotor position according to the current parameter in the two-phase rotational coordinate system and a preset operating parameter of the winch motor using the flux linkage observer-based sensorless observer model and the motor model.

In motor control, Clark transformation is a spatial vector transformation, which serves to convert the three phase change amounts of a three-phase motor to two-phase orthogonal variables. Sampling is performed at startup of the winch motor; three-phase currents Iₐ, I_{b}, I_{c} are obtained by subtracting the static initial value from respective three-phase startup currents of the winch motor, respectively; the currents Iₐ, I_{b}, I_{c}, are subjected to Clark transformation to current parameters in the two-phase stationary coordinate system expressed below:

$$[ \begin{matrix}{I}_{α} \\ {I}_{β}\end{matrix} ] = [ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}{I}_{a} \\ {I}_{b} \\ {I}_{c}\end{matrix} ]$$

where I_{α} and I_{β} are current parameters in the two-phase stationary coordinate system.

Furthermore, Park transformation is applied to convert the amount of AC power in the two-phase stationary coordinate system to an amount of DC power in the two-phase rotational coordinate system; through Park transformation, the current parameters in the two-phase stationary coordinate system are converted to the current parameters in the two-phase rotational coordinate system, expressed by the equation below:

$$[ \begin{matrix}{I}_{d} \\ {I}_{q}\end{matrix} ] = [ \begin{matrix}cos θ & cos ( θ + \frac{π}{2} ) \\ - sin θ & - sin ( θ + \frac{π}{2} )\end{matrix} ] [ \begin{matrix}{I}_{α} \\ {I}_{β}\end{matrix} ] = [ \begin{matrix}cos θ & - sin θ \\ sin θ & cos θ\end{matrix} ] [ \begin{matrix}{I}_{α} \\ {I}_{β}\end{matrix} ]$$

thereby obtaining:

$${I}_{d} = {I}_{α} cos θ + {I}_{β} sin θ ;$$

$${I}_{q} = {I}_{β} cos θ - {I}_{α} sin θ ;$$

after obtaining the currents in the two-phase rotational coordinate system, the current parameters in the two-phase rotational coordinate system are inputted to the flux linkage observer-based sensorless observer model; the q-axis flux linkage is obtained using the flux linkage observer, and then the electrical angle of the rotor is calculated as the rotor position based on a change rate of the q-axis flux linkage; then, the d-axis reference current is obtained based on the preset operating parameter of the winch motor. The flux linkage observer is an instrument for magnetic field measurement, a principle of which is calculating the magnitude of flux linkage mainly by measuring a voltage variation in the coil according to the Faraday's law of electromagnetic induction. Therefore, the outputting a d-axis reference current and a rotor position according to the current parameter in the two-phase rotational coordinate system and a preset operating parameter of the winch motor using the flux linkage observer-based sensorless observer model and the motor model further includes:
outputting a q-axis flux linkage using the current parameter in the two-phase rotational coordinate system as an input to the flux linkage observer-based sensorless observer model;
outputting the rotor position based on a change rate of the q-axis flux linkage;
outputting the d-axis reference current based on the preset operating parameter of the winch motor and the motor model.

During operating of the motor, variation of the rotor position leads to variation of the internal magnetic field of the motor, further affecting the q-axis current. For example, in a permanent magnet synchronous motor, when the rotor rotates, the relative position between the magnetic field of the permanent magnet and the stator winding would change, affecting the magnitude and direction of the q-axis current. At startup of the motor, fast change of the q-axis flux linkage may indicate that the rotor is rotating at an accelerated velocity. Therefore, the rotor position may be obtained based on the change rate of the q-axis flux linkage. The q-axis flux linkage is outputted using the flux linkage observer-based sensorless observer model, and by subjecting the q-axis flux linkage to differential processing, the change rate of the q-axis flux linkage is solved, further obtaining the rotor position. A neural network model may be employed to learn relevance features between the change rate of the q-axis flux linkage of the corresponding motor and the rotor position, so that the corresponding rotor position is obtained based on the q-axis flux linkage. By employing the flux linkage observer and giving the d-axis reference current at the startup, the angle open-loop time is shortened; the flux linkage parameter varies according to the rotational speed, so that it is accommodated to wider ranges of rotational speed and startup torque.

The q-axis reference current may be obtained after obtaining the rotor position and the d-axis reference current, and feedback control is performed based on the d-axis reference current, the q-axis reference current, and the startup current of the winch motor. By real-time adjusting the voltage and current applied on the motor, stable and fast startup of the motor is ensured so that the motor reaches the preset operating state as fast as possible, which also enhances operating accuracy of the winch motor. In this implementation, the preset operating parameter of the winch motor at least includes an operating load of the winch motor.

In this implementation, the step S1 further includes:
building a basic parameter timing variation model of the winch motor based on historical basic parameter data of the winch motor, and outputting the basic parameter of the winch motor based on present timing and the basic parameter timing variation model of the winch motor.

By obtaining variation of the basic parameter of the winch motor with motor operating time based on the historical basic parameter data of the winch motor to thereby build a basic parameter timing variance model of the winch motor, identifying offline the basic parameter of the winch motor based on present timing, and updating the basic parameter of the winch motor, the calculation accuracy of subsequent feedback control is enhanced, further enhancing operating accuracy of the motor.

During operating of the winch motor, the operating parameter of the winch motor is monitored in real time, and the real-time rotational speed and the real-time winding/unwinding position of the winch motor are obtained based on the operating parameter of the winch motor. The obtaining a real-time rotational speed and a real-time winding/unwinding position of the winch motor according to the operating parameter of the winch motor using the flux linkage observer-based sensorless observer model further includes:
outputting an angular velocity according to the operating parameter of the winch motor using the flux linkage observer-based sensorless observer model, and calculating the real-time rotational speed and the real-time winding/unwinding position according to the angular velocity.

The real-time rotational speed is calculated based on the angular velocity according to the equations given below:

$$f = \frac{{ω}_{e}}{2 π}$$

$$SpdFbk = \frac{60 f}{p} ;$$

where f denotes the electrical frequency, SpdFbk denotes the real-time rotational speed, and P denotes the number of pole pairs.

Meanwhile, the rotor angle may be obtained by angular velocity integration, and then the real-time winding/unwinding position of the winch motor is obtained. By superimposing the rotor angles at each time step of startup, the total angle rotated by the rotor from the startup time is obtained, and by converting the total angle rotated by the rotor to a mechanical angle, the real-time winding/unwinding position of the winch motor is determined based on the mechanical angle, i.e., the position of the rope or object on the winch is obtained based on the total angle rotated by the rotor.

The total angle rotated by the rotor is given as:

$${θ}_{𝓏} = {\sum }_{t 1}^{T} {ω}_{e , t} Δ t$$

where Δt denotes a sampling internal, T denotes the present total sampling time, and ω_{e,t} denotes the angular velocity of time t.

The mechanical angle is given as:

$${θ}_{m} = \frac{{θ}_{𝓏}}{p}$$

where θₘ denotes the mechanical angle.

The calculating the real-time winding/unwinding position based on the angular velocity further includes:
outputting the mechanical angle of the winch motor based on the present total sampling time and the corresponding angular velocity; and
outputting the real-time winding/unwinding position based on the basic parameter of the winch motor and the mechanical angle of the winch motor.

The rope travel length traversed by the winch drum at each rotation of a certain angle may be calculated based on winch design specifications (i.e., winch parameters). The angle rotated by the rotor is converted to the number of turns rotated by the winch drum, and then the total rope travel length is obtained based on the number of turns rotated by the winch drum in conjunction with the travel length of each turn of the rope; the real-time winding/unwinding position of the winch motor is the sum of or the difference between the initial position and the total rope travel length. It may be understood that, the real-time winding/unwinding position of the winch motor is the real-time position of the object hoisted by the winch; during unwinding of the winch, the real-time winding/unwinding position of the winch motor is the sum of the initial position and the total rope travel length; during winding of the winch, the real-time winding/unwinding position of the winch motor is the difference between the initial position and the total rope travel length.

Furthermore, a preset position and a preset rotational speed in the preset operating parameter of the winch motor are retrieved, a first offset between the real-time winding/unwinding position and the preset position and a second offset between the real-time rotational speed and the preset rotational speed are obtained, and closed-loop control is performed with the first offset and the second offset as feedback parameters. The speed closed-loop and current loop control may be implemented by speed loop P1 and q-axis PI; the speed loop P1 controller outputs a set value of the current loop based on the second offset, and the q-axis PI controller controls the q-axis current of the motor (i.e., the torque current of the motor), thereby realizing current loop control. Fast response of the current loop ensures accurate control of the motor torque and high-accuracy control of motor speed.

In this implementation, an SVPWM (Space Vector Pulse Width Modulation) scheme is adopted to output three channels of complementary PWMs through sector determination and acting time calculation in conjunction with the carrier, the three channels of complementary PWMs passing through six hardware drive channels to output the actual voltage to the motor, which realizes more effective utilization of the DC voltage source and enhanced voltage usage; therefore, under the same DC voltage source condition, the motor may obtain a higher output voltage, achieving optimization of the operating efficiency of the motor. Meanwhile, by sampling the DC-side bus current and monitoring the current magnitude in real time, long-time overload is prevented while realizing power control, thereby ensuring stable operation of the system.

Step S2 further includes:
outputting the preset position and the preset rotational speed according to the winch motor startup signal using the motor model.

The winch motor startup signal at least includes load magnitude and startup time; in the case of outputting the present load magnitude based on the motor model, the theoretical rotational speed for stable operation of the motor is taken as the preset rotational speed, and the theoretical position at each point of time when the motor operates at the theoretical rotational speed is taken as the preset position.

In this case, step S4 further includes:
obtaining present timing, and obtaining the preset position and the preset rotational speed according to the present timing.

By performing feedback control based on the offset between the theoretical stable operation and the actual operation of the motor, the winch motor can operate as needed.

In accurate hoist operations, special operations, or maritime engineering, it is needed to accurately control the winding/unwinding time of the winch motor to ensure operation safety and efficiency; therefore, step S4 further includes:
calculating, based on the first offset, a compensating value for the second offset, performing closed-loop control of the operating parameter with the second offset and the compensating value for the second offset as feedback parameters, and adjusting the operating parameter to optimize operating accuracy of the winch motor.

In this implementation, the compensating value for the second offset is calculated based on the first offset, the first offset being an offset between the real-time winding/unwinding position of the winch motor and the preset position, i.e., the offset distance between the actual arrival position of the hoisted object and the preset desired arrival position; an adjustment value for the second offset is calculated based on the offset distance. For example, when the actual arrival position of the hoisted object exceeds the preset desired arrival position, it is needed to slow down the rotational speed of the motor so as to compensate for the extra arrival distance to prevent advance arrival of the hoisted object; when the actual arrival position of the hoisted object is shorter than the preset desired arrival position, it is needed to accelerate the rotational speed of the motor so as to compensate for the shortened distance to prevent delayed arrival of the hoisted object. In this case, calculating, based on the first offset, the compensating value for the second offset includes:
calculating the compensating value for the second offset based on the first offset and a sampling interval.

By calculating, based on the first offset and the sampling interval, a compensating rotational speed that is needed to finish the offset distance within the sampling interval as the compensating value for the second offset, hoisting stability and accuracy are ensured.

As a second implementation of the disclosure, the step below is performed before step S1:
S0: obtaining a relevance function between a rope travel length of the winch motor and a rotor angle of the winch motor.

Step S3 further includes:
obtaining a corresponding relevance function between the rope travel length of the winch motor and the rotor angle of the winch motor based on winch parameters, and outputting the real-time winding/unwinding position based on the relevance function and a mechanical angle of the winch motor.

With constant increase of the number of layers of the rope wound around the drum, the radius increases, and the rope travel length of each turn of rotation also constantly increases; therefore, by compensating for the extra rope travel length due to increase of the number of turns of the wound rope based on the relevance function between the rope travel length of the winch motor and the rotor angle of the winch motor, the operating accuracy of the winch motor is enhanced. The winch motor is usually a brushless motor; when sampling current without load on the winch, the torque of the brushless motor does not change, and the current also has no noticeable change. The no-load rope winding/unwinding function is thus achieved with constant rotational speed and invariable torque outputted by the winch. Now, the rope travel length and the rotor angle of the winch motor are acquired as a basis for constructing a relationship between the rope travel length and the rotor angle of the winch motor, serving as the relevance function between the rope travel length of the winch motor and the rotor angle of the winch motor.

Variation of the winch load leads to variation of the torque of the brushless motor, and meanwhile the current also varies noticeably with increase of the torque. When receiving data change feedback, the controller calculates feedback power based on a product of feedback current and voltage; the feedback power is compared with the target power, with the offset therebetween being subjected to PI calculation, so that change of the parameters such as the torque and current of the brushless motor is related to change of the winch load. The winch is driven by the brushless motor assembly to create a torque, and the coupler and the drive rod actuate the reducer gearbox assembly and the gear train to output the torque, bringing the winch drum to rotate, whereby the rope wound around the drum induces variation of the towing/hoisting operating speed of the winch. Meanwhile, with constant increase of the number of layers of the rope wound around the drum, the radius increases. Ensuring that the nominal load torque does not change, the load is decreased layer by layer, while the rope winding speed of the winch is accelerated layer by layer. The constant motor torque and current cause no impact on the winch, protecting the winch or the vehicle or object connected to the winch. The control system compares the actual rotational speed of the motor fed back from the sensorless model with the preset rotational speed, with the offset therebetween being subjected to PI calculation for dynamic adjustment of the rotational speed, resulting in a constant rotational speed of the motor. Then, the constant rotational speed is further driven and outputted by the brushless motor assembly, and the coupler and the drive rod actuate the reducer gearbox assembly and the gear train to output a constant torque bringing the drum to rotate, so that the rope wound around the drum maintains a constant towing/hoisting speed; therefore, the winch is contributed with a speed stabilizing function; within the nominal load range, the speed fluctuation is small, and the towing/hoisting process maintains a consistent operating speed, thereby enhancing safety.

In this implementation, the step S3 further includes:
monitoring the operating parameter of the winch motor in real time, outputting real-time current of the winch motor according to the operating parameter of the winch motor using the flux linkage observer-based sensorless observer model and the motor model, and when the real-time current of the winch motor exceeds a preset current threshold, controlling the motor to stop.

During towing/hoisting process of the winch, load variation of the towed/hoisted object is monitored in real time; the load variation leads to current change; when the load is 20% above the nominal load, the current would exceed the preset protection value; after software filtering, the motor stops operating after overload determination; then, the winch stops towing/hoisting to protect the winch or the vehicle or object attached to the winch. In this implementation, the operating parameter of the winch motor at least includes load; the winch motor startup signal at least includes a preset current threshold, the preset current threshold=(1+20%)*nominal current.

In a third implementation of the disclosure, step S0 further includes:
obtaining a relevance function between the torque of the winch motor and the rotor angle of the winch motor.

Step S2 further includes:
outputting the preset position and the preset rotational speed according to the winch motor startup signal using the motor model and the relevance function between the torque of the winch motor and the rotor angle of the winch motor.

The mass of the towed/hoisted vehicle or object does not change. During towing/hoisting, as the rope is wound around the winch drum, the number of wound layers increases, and the radius of the drum also increases; since the mass of the object does not change, to control the motor power constant, the required motor torque should also increase to realize that the pulling force of each layer of the drum is equal. With increase of the motor torque and decrease of the rotational speed of the motor, a constant power control needs to be maintained. The moving speed of the towed/hoisted vehicle or object within the nominal load range would change as the number of layers of the rope wound around the drum increases. By outputting the rotational speeds and winding/unwinding positions of the winch motor at different timing using the motor model and the relevance function between the torque of the winch motor and the rotor angle of the winch motor, a corresponding rotational speed is matched based on the rotor angle, so that the actual rotational speed is adjusted to match the constant power control, whereby the operating accuracy of the motor is enhanced.

Step S5 further includes:
calculating a power-based third offset based on the first offset and the second offset, performing closed-loop control of the operating parameter with the third offset as a feedback parameter, and adjusting the operating parameter to optimize operating accuracy of the winch motor.

In this implementation, DC-side bus current and bus voltage are sampled; the power-based third offset, i.e., feedback power, is calculated based on the first offset and the second offset; the feedback power is compared with the preset power to output an error that is fed to the power loop PI controller and outputted, after being limited by maximum speed, as a q-axis current input reference. When the load increases, the feedback power increases; when the load decreases, the feedback power decreases. By dynamically adjusting the rotational speed based on the load amount, a fast speed under a light load and a slow speed under a heavy load are realized, thereby achieving the objective of constant power control. Now, step S2 further includes:
outputting a preset position, a preset rotational speed, and a preset power according to the winch motor startup signal using the motor model and the relevance function between the torque of the winch motor and the rotor angle of the winch motor.

The extra resistance or load that the winch motor needs to overcome is obtained based on a position offset, i.e., the load variation has a direct influence on the output power of the motor. Increase of the position offset might indicate load increase or system efficiency deterioration, which generally needs more power to maintain a constant output power. Variation of the rotational speed would also lead to corresponding variation of the mechanical power. The power offset is obtained based on the rotational speed offset and the position offset, whereby feedback control is performed based on the power offset.

In the present application, by obtaining the first offset between the real-time winding/unwinding position of the winch motor and the preset position and the second offset between the real-time rotational speed of the winch motor and the preset rotational speed, a compensating rotational speed for the winch motor required to hoist the object to the destination within the preset time is calculated as a feedback parameter to adjust the operating parameter of the motor, so as to satisfy high-accuracy control requirement of moving the object to the destination within the preset time. For example, in some assembly line, objects need to access the assembly line at a constant interval to ensure automatic operation of the assembly line. Meanwhile, a compensating power for the winch motor required to hoist an object to the destination under a constant power is also calculated; in a case that load variation occurs to the winch motor, the compensating power is calculated to obtain a power that can satisfy the present load condition, so that irrespective of how the load varies, the winch motor can always hoist the object with a constant power, thereby ensuring operating safety and efficiency. For example, if the load of the winch motor increases, it is needed to increase the output power of the motor to overcome the increased resistance; on the contrary, if the load decreases, it is needed to reduce the output power of the motor to an appropriate extent so as to avoid power waste and potential device overheat, thereby ensuring stable operation of high-accuracy work.

The implementations described above are only exemplary implementations of the method for optimizing operating accuracy of the brushless winch motor according to the disclosure, not intended for limiting the scope of the disclosure. The scope of the disclosure is not limited to the implementations. Any equivalent changes based on the shape and configuration of the disclosure will fall within the scope of protection of the disclosure.

What is claimed is:

1. A method for optimizing operating accuracy of a brushless winch motor, the method comprising:
obtaining a basic parameter of the winch motor building a motor model based on the basic parameter of the winch motor, and building a flux linkage observer-based sensorless observer model based on the motor model;
obtaining a winch motor startup signal at startup of the winch motor, outputting a d-axis reference current and a rotor position according to the winch motor startup signal using the flux linkage observer-based sensorless observer model and the motor model, and adjusting a winch motor startup parameter based on the d-axis reference current and the rotor position;
monitoring an operating parameter of the winch motor in real time, and obtaining a real-time rotational speed and a real-time winding/unwinding position of the winch motor according to the operating parameter of the winch motor using the flux linkage observer-based sensorless observer model and the motor model; and
obtaining a first offset between the real-time winding/unwinding position of the winch motor and a preset position and a second offset between the real-time rotational speed of the winch motor and a preset rotational speed, performing closed-loop control of the operating parameter with the first offset and the second offset as feedback parameters, and adjusting the operating parameter to optimize operating accuracy of the winch motor.

2. The method according to claim 1, wherein the obtaining a winch motor startup signal at startup of the winch motor, outputting a d-axis reference current and a rotor position according to the winch motor startup signal using the flux linkage observer-based sensorless observer model and the motor model, and adjusting a winch motor startup parameter based on the d-axis reference current and the rotor position further comprises:
converting a winch motor startup current via Clark transformation to a current parameter in a two-phase stationary coordinate system;
converting the current parameter in the two-phase stationary coordinate system via Park transformation to a current parameter in a two-phase rotational coordinate system; and
outputting the d-axis reference current and the rotor position according to the current parameter in the two-phase rotational coordinate system and a preset operating parameter of the winch motor using the flux linkage observer-based sensorless observer model and the motor model.

3. The method according to claim 2, wherein the outputting the d-axis reference current and the rotor position according to the current parameter in the two-phase rotational coordinate system and a preset operating parameter of the winch motor using the flux linkage observer-based sensorless observer model and the motor model further comprises:
outputting a q-axis flux linkage using the current parameter in the two-phase rotational coordinate system as an input to the flux linkage observer-based sensorless observer model;
outputting the rotor position based on a change rate of the q-axis flux linkage; and
outputting the d-axis reference current based on the preset operating parameter of the winch motor and the motor model.

4. The method according to claim 1, wherein the obtaining a basic parameter of the winch motor, building a motor model based on the basic parameter of the winch motor, and building a flux linkage observer-based sensorless observer model based on the motor model further comprises:
building a basic parameter timing variation model of the winch motor based on historical basic parameter data of the winch motor, and outputting the basic parameter of the winch motor based on present timing and the basic parameter timing variation model of the winch motor.

5. The method according to claim 1, wherein the obtaining a real-time rotational speed and a real-time winding/unwinding position of the winch motor according to the operating parameter of the winch motor using the flux linkage observer-based sensorless observer model further comprises:
outputting an angular velocity according to the operating parameter of the winch motor using the flux linkage observer-based sensorless observer model, and calculating the real-time rotational speed and the real-time winding/unwinding position according to the angular velocity.

6. The method according to claim 1, wherein the obtaining a winch motor startup signal at startup of the winch motor, outputting a d-axis reference current and a rotor position according to the winch motor startup signal using the flux linkage observer-based sensorless observer model and the motor model, and adjusting a winch motor startup parameter based on the d-axis reference current and the rotor position further comprises:
outputting the preset position and the preset rotational speed according to the winch motor startup signal using the motor model.

7. The method according to claim 1, wherein the obtaining a first offset between the real-time winding/unwinding position of the winch motor and a preset position and a second offset between the real-time rotational speed of the winch motor and a preset rotational speed, performing closed-loop control of the operating parameter with the first offset and the second offset as feedback parameters, and adjusting the operating parameter to optimize operating accuracy of the winch motor further comprises:
calculating, based on the first offset, a compensating value for the second offset, performing closed-loop control of the operating parameter with the second offset and the compensating value for the second offset as feedback parameters, and adjusting the operating parameter to optimize operating accuracy of the winch motor.

8. The method according to claim 1, further comprising before the obtaining a basic parameter of the winch motor, building a motor model based on the basic parameter of the winch motor, and building a flux linkage observer-based sensorless observer model based on the motor model:
obtaining a relevance function between a rope travel length of the winch motor and a rotor angle of the winch motor.

9. The method according to claim 8, wherein the monitoring an operating parameter of the winch motor in real time, and obtaining a real-time rotational speed and a real-time winding/unwinding position of the winch motor according to the operating parameter of the winch motor using the flux linkage observer-based sensorless observer model and the motor model further comprises:
obtaining a corresponding relevance function between the rope travel length of the winch motor and the rotor angle of the winch motor based on winch parameters, and outputting the real-time winding/unwinding position based on the relevance function and a mechanical angle of the winch motor.

10. The method according to claim 1, wherein the monitoring an operating parameter of the winch motor in real time, and obtaining a real-time rotational speed and a real-time winding/unwinding position of the winch motor according to the operating parameter of the winch motor using the flux linkage observer-based sensorless observer model and the motor model further comprises:
monitoring the operating parameter of the winch motor in real time, outputting real-time current of the winch motor according to the operating parameter of the winch motor using the flux linkage observer-based sensorless observer model and the motor model, and when the real-time current of the winch motor exceeds a preset current threshold, controlling the motor to stop.
